(19) United States
(12) Patent Application Publication
(10) Pub. No.: US 2009/0320446 A1
(43) Pub. Date: Dec. 31, 2009

(54) Performance improvements for pulse detonation engines

(76) Inventors: Ephraim J. Gutmark, Cincinnati, OH (US); Daniel C. Allgood, Walker, LA (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/509,311

(22) Filed: Aug. 24, 2006

Related U.S. Application Data
(60) Provisional application No. 60/711,032, filed on Aug. 24, 2005.

(51) Int. Cl. F02K 5/02; F02K 1/00

(52) U.S. Cl. 60/247; 60/770

(57) ABSTRACT

A device and method for improving the performance of a pulse detonation engine. The device includes at least one of an exhaust structure and an ejector. The exhaust structure can be configured as a straight, converging or diverging nozzle device, and connected to the engine to control the flow of a primary fluid produced during a detonation reaction. The ejector is fluidly coupled to the engine, using the movement of the primary fluid to promote entrainment of a secondary fluid that can be mixed with the primary fluid. The secondary fluid can be used to increase the mass flow of the primary fluid to increase thrust, as well as be used to cool engine components. Device positioning, sizing, shaping and integration with other engine operating parameters, such as fill fraction, choice of fuel and equivalence ratio, can be used to improve engine performance. In addition to thrust augmentation and enhanced cooling, the disclosed device can be used for engine noise reduction.

This application claims the benefit of the filing date of U.S. Provisional Application No. 60/711,032, filed Aug. 24, 2005.

### STATEMENT REGARDING FEDERALLY SPONSORED RESEARCH OR DEVELOPMENT

This invention was made with Government support under Contract No. F33615-03-D-2829, awarded by The U.S. Air Force. The Government has certain rights in this invention.

### BACKGROUND OF THE INVENTION

The present invention generally relates to the control of fluid flow corresponding to the operation of a pulse detonation engine (PDE) in a conduit, and more particularly to the use of external airflow and nozzle configuration to control exhaust flowing from the pulse detonation engine.

In traditional air-breathing propulsion systems, a combustible mixture of air and fuel are burned in a deflagration reaction. Included among these systems for aircraft applications are gas turbine (et) and propeller-based engines. Such reaction yields low to moderate levels of extractable energy per a given amount of fuel consumed during the relatively steady-state, subsonically-propagating combustion process. With regard to gas turbine engines in particular, one way to increase the thrust is to direct bypass airflow into the engine exhaust stream with an ejector, thereby increasing the mass flow of gas through the throat of the engine's exhaust nozzle or related structure. A typical ejector is made up of a coaxial duct that is placed around the exhaust of an engine, and includes a passageway that allows a fluid (such as air) to be routed concentrically inward from the outer duct to the exhaust duct. The ejector effectively functions as a pump, promoting the entrainment of fluid from the outer duct (typically called the secondary flow path) into the primary inner duct (typically called the primary flow path). In addition to contributing to the augmentation of thrust, ejectors have been used to provide additional cooling to exhaust ducts as well as to nozzle convergent and divergent flaps and the liners used to cover them. Accordingly, the use of ejectors in conventional gas turbine engines is well established.

Another way to increase the thrust is to use a converging nozzle for subsonic applications, and a converging-diverging nozzle for supersonic applications. By tailoring nozzle area ratios to correspond to particular regimes within the flight envelope, operability of the propulsion system is improved. As with the ejector, converging and converging-diverging nozzles are well-known in traditional gas turbine applications.

There has been a recent interest in PDEs, also known as pulse detonation wave engines, as supplements to or replacements for the aforementioned traditional propulsion systems. PDEs exploit the inherently high levels of energy available from the generation of a supersonic wavefront produced by a detonation reaction of the combustible mixture. A PDE is essentially a pipe or tube that is substantially closed at a forward end and open at the rear end. Air, fuel and ignition sources, along with appropriate valving and conduit, are used to introduce reactants into the pipe. By employing a series of repetitive detonations within a detonation chamber, a PDE can produce a high pressure detonation wave that compresses fluid (such as another fuel-air mixture) within the detonation chamber. As the supersonic detonation wave and the high pressure fluid exit an open end of the chamber, they expand, producing forward thrust. By approximating a constant volume (i.e., pressure-raising) combustion process, a PDE can operate with greater thermodynamic efficiency than the comparable constant pressure combustion process of conventional gas turbine or related internal combustion engines. As such, PDEs can be used as stand-alone propulsion systems, in combination with a conventional propulsion system (such as a turbofan or turbojet engine), or as a hybrid with a turbofan or turbojet, where the conventional combustion system of the turbomachinery is replaced by the detonation combustion equipment of the PDE.

The operation of a conventional PDE, while theoretically straightforward, requires precise balances of fuel, oxidant and timing of filling, mixing, combusting and exhausting factors to ensure proper engine operation. Much of this is dictated by the inherent properties of the fuel source and the pressure requirements to initiate a detonation reaction. For example, although a preferred combustion process would involve the direct initiation of a detonation reaction, conventional fuels, including hydrocarbon-based liquids and gases, require a relatively large input of energy (such as to raise the pressure of the fuel-oxidizer mixture) to get the fuels to directly initiate a detonation. An alternate to direct-initiation of a detonation reaction is to employ a two-stage deflagration-to-detonation approach. In one form, a small quantity of a fuel-oxidizer mixture is introduced into a pre-detonation chamber adjacent the closed end of the pipe. This mixture is then ignited in a conventional deflagration reaction, then made to detonate by rapidly forcing it through a tortuous path configured to promote turbulence. This turbulence in turn fosters burning at a rate that increases the heat release rate, leading to the generation of compression waves that subsequently forms a supersonic shockwave, in what is frequently referred to as deflagration to detonation transition (DDT). This shockwave is then introduced into the main detonation chamber, where by virtue of the detonation shockwave's extremely high pressure and speed, it overtakes a fuel-air mixture previously introduced into the main detonation chamber, causing compression of the fuel-air mixture to an extent necessary to promote its detonation. Even though the rear end of the pipe is open, the supersonic propagation of the initial shockwave and its resulting compression of the fuel-air mixture occurs faster than the fuel-air mixture can be exhausted from the pipe, such that when the main fuel-air mixture detonates, the increased pressure of the exhaust gasses creates a significant thrust against the forward (closed) end of the pipe.

PDEs hold the promise for significant improvements over conventional air-breathing engines. Nevertheless, airframe integration, thrust augmentation, exhaust system cooling and related operability schemes that have been employed in the relatively steady-flow environment of conventional propulsion systems do not appear to have been integrated into emerging PDE concepts. Accordingly, improvements incorporating these schemes are desired to exploit as much of the performance benefits inherent in PDEs as possible.

### BRIEF SUMMARY OF THE INVENTION

These desires are met by the present invention, wherein improved PDE operability through proper integration with exhaust nozzles, ejectors or both is described. The present inventors have discovered that the unsteady (i.e., time-varying) nature of PDE operation could hold additional promise for ejectors, nozzles and related thrust augmentation schemes, as the unsteady flow of a primary fluid (such as the combustion products) is more efficient in producing mass entrainment than a comparable steady-state (non time-varying) flow. For example, such increases in unsteady ejector performance could be attributed to (among other things) a more efficient energy transfer process between the primary flow and the secondary (entrained) flow through inviscid processes, while the steady ejector relies primarily on viscous shear mixing.

According to an aspect of the present invention, an ejector for improved operability of a PDE is disclosed. The ejector includes an inlet section and an outlet section. The inlet section is fluidly coupled to both a primary fluid flow source emanating from the PDE and a secondary fluid flow source. The outlet section is in fluid communication with the inlet section, and is configured such that the movement of a primary fluid through it promotes entrainment of a secondary fluid through the inlet section. In such capacity, the ejector acts as a pump to introduce the secondary fluid into the primary fluid stream being exhausted from the PDE.

Optionally, the outlet section can be configured to define a converging, diverging or substantially straight flow path. In addition, the outlet section can define either a substantially axisymmetric fluid flow path or a non-axisymmetric flow path, the latter for example configured as a substantially two-dimensional fluid flow path. In the present context, the term “substantially” is utilized to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The term also represents the degree by which a quantitative representation may vary from a stated reference without resulting in a change in the basic function of the subject matter at issue. In another option, the inlet section may include a contoured lip to avoid the onset of separated flow along the ejector inlet section. Moreover, the length of the ejector relative to the ejector diameter may be configured to fall within a preferred ratio, such as between three and four. It will be appreciated by those skilled in the art that the diameter is a convenient measure of the ejector flow path size, defining an equivalent exit area in the ejector's outlet section. Thus, even if the outlet section is not of axisymmetric shape, an equivalent diameter exits based on the exit area. It will further be appreciated that other area ratios are contemplated, and may be formed based on the operational needs of the PDE. Other such area ratios are within the scope of the present invention. In yet another option, an ejector intermediate section may be disposed between the inlet and outlet sections, thereby increasing the overall length of the ejector.

According to another aspect of the invention, a PDE is disclosed. The engine includes a detonation chamber configured to generate a time-varying primary fluid, an exhaust structure defining an opening to accept the primary fluid therethrough, and an ejector fluidly coupled to the exhaust structure such that upon operation of the PDE, the movement of the primary fluid from the PDE promotes entrainment of a secondary fluid through the ejector. Generally, a time-varying primary fluid is one where the fluid produces thrust through intermittent pulses or bursts, rather than through a relatively constant stream.

Optionally, the exhaust structure may be in the form of an exhaust nozzle. The nozzle can accept a primary fluid through it from the PDE, and such primary fluid movement promotes entrainment of a secondary fluid to pass through the ejector and into a primary fluid flow path defined by the exhaust nozzle. Optionally, the ejector is made up of at least an inlet section and an outlet section as discussed in conjunction with the previous aspect. The ejector's inlet section is fluidly coupled to both the exhaust nozzle and a source of the secondary fluid, while the ejector's outlet section is in fluid communication with the inlet section. The relative axial position between the exhaust nozzle of the PDE and the inlet section of the ejector can be varied. For example, in one configuration, the two are aligned substantially coaxial with one another. In another, an exit plane defined in the exhaust nozzle is axially aligned with an inlet plane defined in the ejector inlet section, while in yet another, an exit plane defined in the exhaust nozzle is axially upstream of the inlet plane. In still another configuration, the exit plane defined in the exhaust nozzle is axially downstream of the ejector inlet plane. The cross-sectional area of the ejector can be made larger than that of the exhaust nozzle. In one option, it is at least twice as large as an axially corresponding cross-sectional area of the exhaust nozzle. In one particular embodiment, the cross-sectional area of the ejector is between 2.5 and 3 times as large as the axially corresponding cross-sectional area of the exhaust nozzle, while in a more preferred embodiment, the ratio is approximately 2.75 times larger. Similarly, the length of the ejector is between 3 and 4 times as large as exit area of its outlet section. As discussed above, it is within the scope of the present invention to vary these ratios in accordance with operational needs of the PDE. Also as before, the ejector can define either a substantially axisymmetric or substantially non-axisymmetric flow path. In another option, the ejector defines a varying cross-sectional area along its lengthwise dimension. Such varying cross-sectional area may define a substantially converging or diverging shape.

In further options, the exhaust structure can be configured as a converging nozzle, diverging nozzle or combination of the two. Furthermore, the outlet section of the ejector can be made to substantially converge, diverge or be straight, depending on the need. The exhaust nozzle of the PDE and the outlet section of the ejector can be made to be substantially coaxial.

In yet another option, an aircraft (alternately referred to as an air vehicle) employing a PDE is disclosed. In the present context, an aircraft is any manned or unmanned vehicle that through a combination of aerodynamic surfaces, propulsion and flight control components is capable of sustained flight. As with the previous aspects of the invention, the PDE may include ejectors, nozzles or combinations of the two in order to improve its performance, as well as that of an aircraft incorporating the PDE. The ejector or nozzle features are preferably integrated into the aircraft design to optimize air vehicle performance.

According to yet another aspect of the present invention, a pulse detonation engine including a detonation chamber, exhaust structure and one or more engine performance enhancement devices is disclosed. As with the previous aspects, the detonation chamber is configured to generate a time-varying primary fluid, while the exhaust structure accepts a primary fluid that is generated by the detonation chamber. The engine performance enhancement device includes one or both of a nozzle and an ejector, and is fluidly coupled to the exhaust structure so that when the exhaust (in the form of the time-varying primary fluid) passes through the device, at least one performance parameter of the pulse detonation engine is enhanced. Such performance parameter may include increased thrust, decreased noise or lower temperature of the fluid passing through the engine performance enhancement device.

According to still another aspect of the present invention, a method of operating a PDE is disclosed, where the configuration of the PDE includes a detonation chamber configured to contain a primary fluid and a thrust enhancement device fluidly coupled to the detonation chamber. The method includes generating a detonation wave in the detonation chamber and flowing a primary fluid through the thrust enhancement device such that thrust produced by both the thrust enhancement device and the detonation chamber can be used to enhance operability of the PDE.

Optionally, the thrust enhancement device comprises one or both of an exhaust nozzle disposed downstream of the detonation chamber and an ejector. The exhaust nozzle may be configured to define a converging flow path, diverging flow path or combination of the two. In the case of an ejector, the movement of the primary fluid through the ejector promotes entrainment of a secondary fluid through it, mixing with the primary flow. The PDE can be operated over a wide range of fill fractions, where the fill fraction is defined as the ratio of the detonation chamber filled with a detonatable mixture of fuel and oxidant relative to the total detonation chamber volume. In a particular embodiment, the fill fraction is preferably between 0.4 and 1.1, where fill fractions greater than unity represent quantities that spill over into the ambient environment outside the engine. In a particular configuration, the ejector defines a diverging flow path along its outlet section, and may further include a contour along its inlet section to reduce flow separation. In another option, the method further includes defining a fill fraction in the detonation chamber and filling the detonation chamber with a mixture of a fuel and an oxidant in accordance with the fill fraction.

Specific ways of generating the detonation wave in the detonation chamber include introducing fuel and oxidant into the detonation chamber, introducing fuel and oxidant into a pre-detonation chamber (this may be the same kind of fuel and oxidant as that used in the detonation chamber, or may be different), igniting the fuel and oxidant in the pre-detonation chamber to produce a deflagration combustion product, routing the deflagration combustion product through a passage configured to convert the deflagration combustion product into a detonation combustion product, introducing the detonation combustion product into the detonation chamber, using the detonation combustion product to compress the fuel and oxidant in the detonation chamber and detonating the fuel and oxidant in the detonation chamber such that the primary fluid is produced. More specifically, generating a detonation wave in the detonation chamber may include delaying ignition of the fuel and oxidant in the pre-detonation chamber until after a source of at least one of the fuel and oxidant being introduced into the pre-detonation chamber has been fluidly decoupled from the pre-detonation chamber. Thus, for example, if isolation is achieved through the use of valves or related fluid decoupling devices, the ignition would be delayed until at least such time as the valves are closed. The delaying could be later, for example waiting between 0.5 and 7.5 milliseconds after the fluid decoupling. Other forms of ignition delay are also possible; for example, timing the igniting to substantially coincide with a localized compression of the fuel and oxidant in the pre-detonation chamber. This can take advantage of acoustic or pressure conditions within the detonation chamber to best ensure the ignition takes place under a localized pressure rise.

As previously mentioned, the thrust enhancement device comprises one or both of an exhaust nozzle and ejector. As before, the exhaust nozzle may define a varying cross-sectional area along its lengthwise dimension. Also as before, the ejector may also include an inlet section and an outlet section. The inlet section is fluidly coupled to both the exhaust nozzle a source of the secondary fluid, while the outlet section is in fluid communication with the inlet section. Also as previously discussed, the outlet section may define a varying cross-sectional area along its lengthwise dimension. Moreover, an exit plane defined in the exhaust nozzle of the PDE can be axially aligned with an inlet plane defined by the inlet section of the ejector. The ratio between the effective areas (for example, the cross-sectional areas) of the ejector and an axially corresponding cross-sectional area of the exhaust nozzle can be kept within preferred limits, such as between two and one half and three. In a preferred embodiment, the cross-sectional area of the ejector should be maintained between approximately two and three quarters times as large as the axially corresponding cross-sectional area of the exhaust nozzle. In a manner similar to that previously discussed, an exit plane defined in the exhaust nozzle of the PDE can be placed axially upstream, axially downstream or substantially axially aligned with an inlet plane defined by the inlet section of the ejector.

According to still another aspect of the present invention, a method of reducing the noise produced by an operating PDE is disclosed. The configuration of the PDE can be as previously described, where specifically the thrust enhancement device comprises one or both of an exhaust nozzle disposed downstream of the detonation chamber and an ejector. Optionally, the exhaust nozzle may be configured to define a converging or diverging flow path, where a particular embodiment incorporates a converging nozzle with an area ratio in the converging nozzle is between 0.5 and 0.8, preferably approximately 0.6. As with the previous aspect of the invention, a fill fraction may be defined in the detonation chamber, where filling the detonation chamber with a mixture of a fuel and an oxidant in accordance with the fill fraction can be used to optimize performance. An ejector similar to that described in the previous aspects may also be fluidly coupled to the exhaust nozzle to provide noise reduction, cooling or thrust augmentation.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 shows a simplified view of a PDE according to an embodiment of the present invention;

FIG. 2A shows a schematic view of a converging nozzle connected to the PDE of FIG. 1;

FIG. 2B shows a schematic view of a diverging nozzle connected to the PDE of FIG. 1;

FIG. 3A shows a schematic view of an ejector fluidly coupled to the PDE of FIG. 1;

FIG. 3B shows a schematic view of an ejector with a diverging outlet section fluidly coupled to the PDE of FIG. 1;

FIG. 4 shows a schematic view of a PDE with an exhaust nozzle and a diverging ejector with contoured lip according to an alternate embodiment of the present invention;

FIG. 5 shows a sample pressure versus time trace and the phases of the cycle of the PDE of FIG. 4;

FIGS. 6A through 6F show a time sequence of events following a detonation in the PDE of FIG. 4;

FIG. 7A shows a snapshot of primary and secondary fluid flow using an ejector with a sharp-edged lip on the ejector inlet;

FIG. 7B shows a snapshot of primary and secondary fluid flow using an ejector with a contoured lip on the ejector inlet;

FIGS. 8A and 8B show the results of a parametric analysis of ejector performance based on fill fraction variations;

FIG. 9 shows the effect of fill fraction variations on thrust and specific thrust;

FIG. 10 shows the results of normalizing the straight and diverging ejectors using a constant ejector length to diameter ratio;

FIGS. 11A through 11D show a time sequence of events following a detonation through a straight exhaust nozzle and diverging ejector;

FIGS. 12A through 12D show a time sequence of events following a detonation through a converging exhaust nozzle and diverging ejector;

FIGS. 13A through 13D show a time sequence of events following a detonation through a diverging exhaust nozzle and diverging ejector;

FIGS. 14A through 14D show a time sequence of events following a detonation through a diverging exhaust nozzle and diverging ejector where the ejector is situated downstream of the nozzle;

FIGS. 15A through 15D show a time sequence of events following a detonation through a diverging exhaust nozzle and diverging ejector where the ejector is situated substantially coplanar with the nozzle;

FIGS. 16A through 16D show a time sequence of events following a detonation through a diverging exhaust nozzle and diverging ejector where the ejector is situated upstream of the nozzle;

FIG. 17 shows the results of variations in fill fraction on acoustic noise;

FIG. 18 shows the results of variations in nozzle area ratio on acoustic noise;

FIG. 19A shows a range of nozzle shapes and sizes used to conduct scaled laboratory testing using the nozzles of FIG. 19A;

FIGS. 19B through 19H show the results of scale laboratory tests of nozzle variations on PDE performance; and

FIGS. 20A through 20E show the results of scale laboratory tests of ejector variations on PDE performance using the ejectors of FIGS. 3A and 3B.

### DETAILED DESCRIPTION OF THE PREFERRED EMBODIMENTS

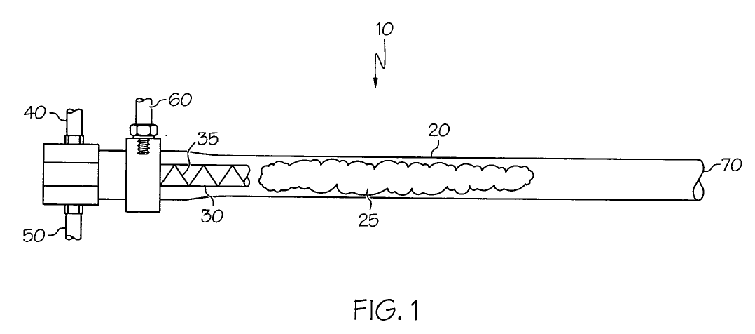

Referring first to FIG. 1, a PDE 10 includes a detonation chamber 20, pre-detonation chamber (also referred to as a deflagration to detonation tube) 30, fuel inlet 40, oxidant inlet 50, ignition source 60 and an exhaust aperture 70 defined at the distal end of detonation chamber 20. Although presently depicted as cylindrical (axisymmetric) pressure vessels, the detonation tube 20 or the exhaust aperture 70 of PDE 10 need not be so configured; for example, they could define a rectangular or other non-axisymmetric flow path. In operation, fuel and oxidant are introduced into detonation chamber 20 through their respective inlets 40, 50, resulting in a fuel-oxidant mixture 25. Although shown as entering through separate inlets and mixing once inside the detonation chamber 20, it will be appreciated that the fuel and oxidant can be introduced into the detonation chamber 20 in a pre-mixed condition. In one form, the fuel can be a gaseous or liquid hydrocarbon, such as ethylene, while the oxidant can be, among others, air. In addition, fuel and oxidant are introduced into the pre-detonation chamber 30 to act as a pilot or trigger for detonation of the fuel-oxidant mixture 25 in the detonation chamber 20. This fuel and oxidant can be the same as that used in the detonation chamber 20, or can be something different. For example, the fuel used in the pre-detonation chamber 30 could be hydrogen. The fuel and oxidant in the pre-detonation chamber 30 is ignited by ignition source 60 (shown presently as a spark plug), after which it can be made to follow a tortuous path 35 to promote turbulence, ensuing pressure rises and consequent formation of a shock wave. In one form, this tortuous path can be achieved with a Schelkin-type spiral or related device. The formed shock wave propagates into the detonation chamber 20, where it pressurizes and subsequently detonates the fuel-oxidant mixture 25, causing a significant pressure rise and subsequent expulsion through exhaust aperture 70. After this, a purge gas (such as air) can be introduced into detonation chamber 20 to isolate the primary exhaust gas from the next incoming charge of fuel and oxidant. There are numerous operating parameters that can be varied for PDE 10, including the fuel and oxidant mixture, the fill fraction, the purge fraction, the ignition delay and the detonation frequency.

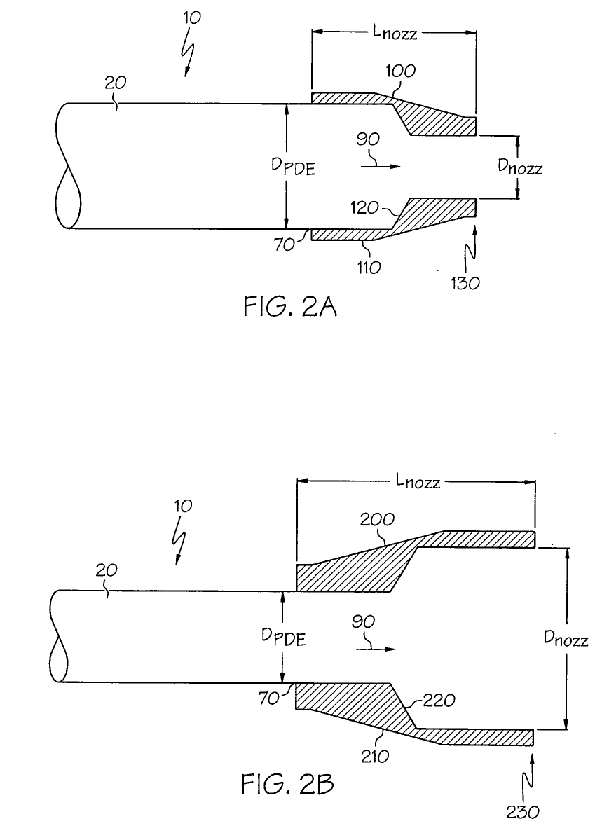

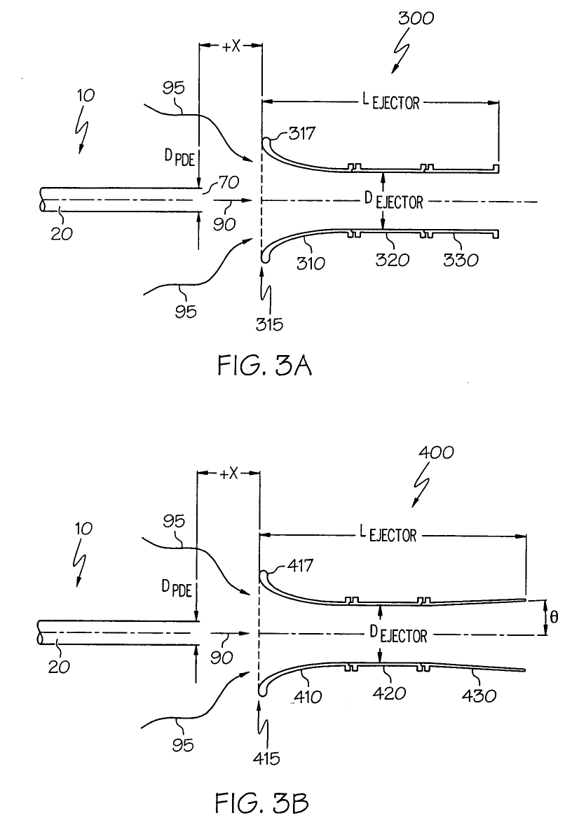

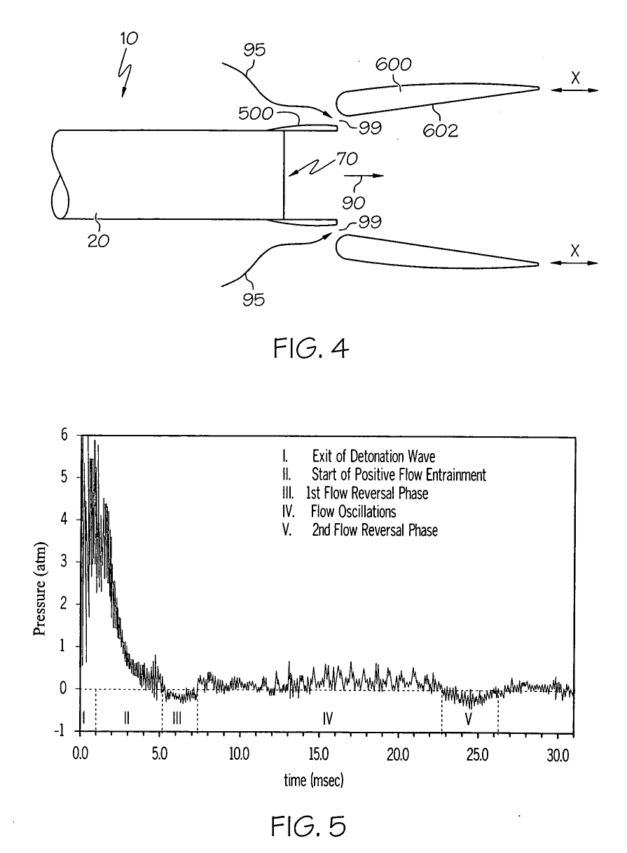

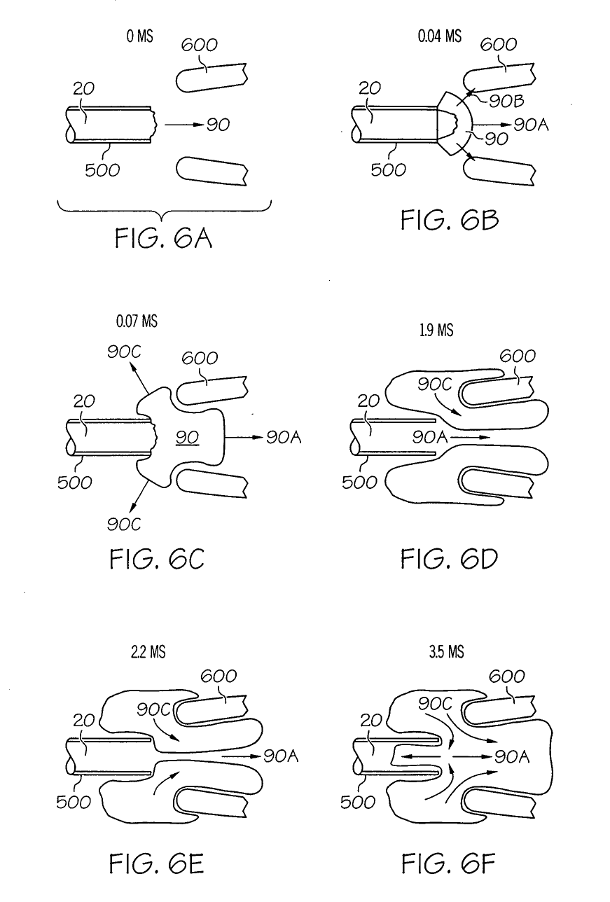

Referring next to FIGS. 2A, 2B, 3A and 3B, the addition of various performance enhancement (in the form of thrust augmentation) devices to PDE 10 is shown. Referring first to FIGS. 2A and 2B, converging nozzle 100 and diverging nozzle 200 are respectively coupled to the distal end of PDE 10, thereby extending exhaust aperture 70 and establishing fluid communication for the primary fluid flow path 90 between detonation chamber 20 and the ambient environment. With the converging nozzle 100 of FIG. 2A, the diameter D_{PDE} (or its equivalent cross-sectional area in cases where the detonation chamber 20 is not axisymmetric) is greater than the diameter D_{NOZZ} at the nozzle exit plane 130 situated at the nozzle distal end, the flow path having gone through a reduction along converging portion 120. Exhaust aperture 70 mates with the proximal portion 110 of converging nozzle 100. The length of nozzle 100 is designated L_{NOZZ}, and spans the longitudinal distance from the nozzle's proximal to distal end. Contrarily, the diverging nozzle 200 of FIG. 2B the diameter D_{NOZZ} at the exit plane 230 is greater than the diameter D_{PDE}. In this case, the flow path experiences an increase in cross-sectional area along diverging portion 220. As with the converging nozzle 100, the exhaust aperture 70 mates with the proximal portion 210 of converging nozzle 200, while the length L_{NOZZ} of nozzle 200 spans the longitudinal distance from the nozzle's proximal to distal end.

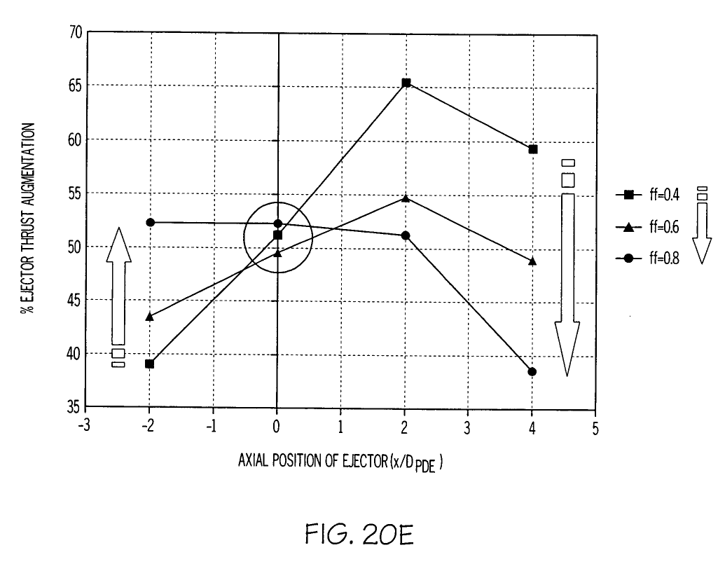

Referring next to FIGS. 3A and 3B, ejectors 300 and 400 are shown disposed downstream of PDE 10 such that fluid coupling is established along primary fluid flow path 90. Ejectors 300, 400 include an inlet section 310, 410 and outlet section 330, 430, where an optional intermediate section 320, 420 can be disposed between the inlet and outlet sections. It will be appreciated by those skilled in the art that in degenerate cases, the intermediate sections 320, 420 become part of outlet sections 330, 430. The inlet sections 310, 410 define an inlet plane 315, 415. When primary fluid is flowing through ejectors 300, 400 along primary fluid flow path 90, the inlet sections 310, 410 act as a venturi such that static a pressure difference that builds up adjacent the inlet section pulls in ambient fluid (for example air, and also referred to as secondary fluid) 95 into primary fluid flow path 90. This causes ejectors 300, 400 to act effectively as pumps for secondary fluid 95. In addition, inlet lip 317, 417 that defines the proximal end of their respective ejectors 300, 400 is shown contoured, thereby minimizing or delaying the onset of flow separation of secondary fluid 95. In the configuration shown, the inlet plane 315, 415 of ejectors 300, 400 is situated downstream of the exit plane defined by either exhaust aperture 70 (in situations where PDE 10 is not outfitted with an exhaust nozzle) or exit plane 130, 230 of the nozzles of FIGS. 2A and 2B. In other configurations (shown and described later), the planes 315, 415 of the ejectors 300, 400 can be positioned in other axial locations relative to the exit plane of the exhaust aperture 70. While the choice of a diverging ejector 400 or a straight ejector 300 is based on operating conditions of the PDE 10, the thrust augmentation of the diverging ejector 400 is greater than that of the straight ejector 300, due in part to the increased thrust surface area of the diverging ejector 400. This increased surface area is related to the divergence angle Θ. Of course, the operating conditions and remainder of the configuration (including, for example, what type of nozzle is used on the exhaust aperture 70) will also influence the amount of additional thrust produced. In a scaled laboratory setup (discussed in conjunction with FIGS. 20A through 20E), the divergence angle was set to four degrees, although other angles could have also been used.

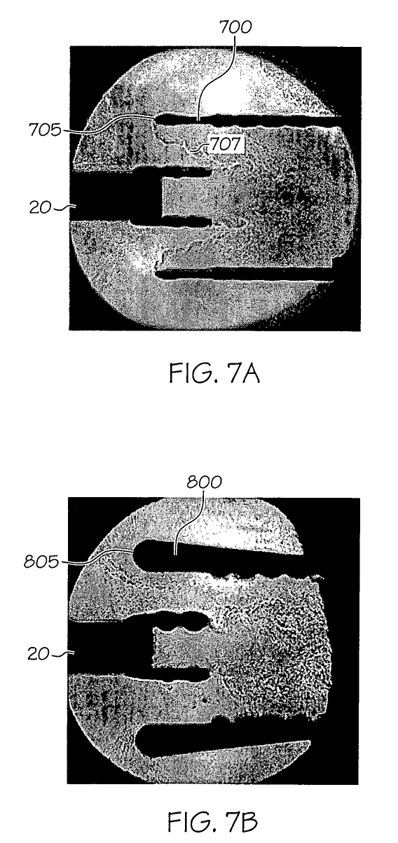

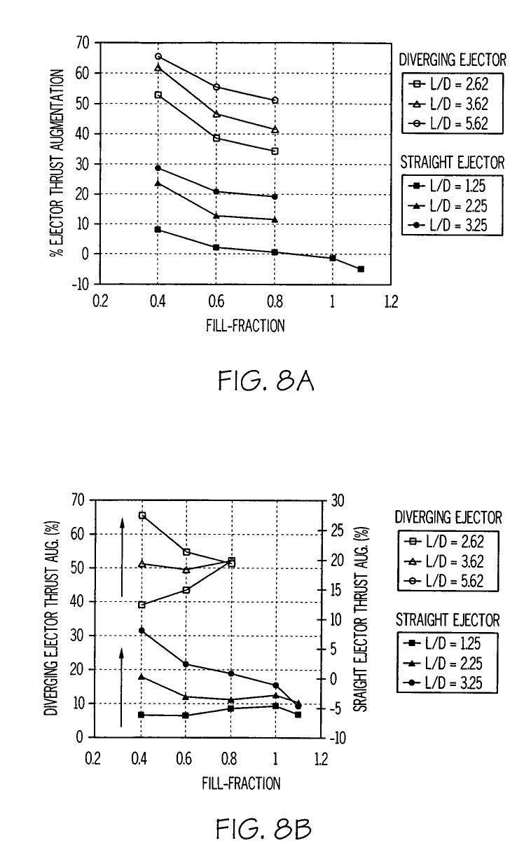

Referring next to FIGS. 4 and 5, PDE 10, with both an exhaust nozzle 500 and an ejector 600, is shown. As can be seen, the flow of primary fluid along primary fluid flow path 90 entrains secondary fluid 95, pulling it through gap 99 between the trailing edge of exhaust nozzle 500 and the leading edge of ejector 600. Arrows along longitudinal dimension X indicate that the axial placement of ejector 600 relative to the exhaust nozzle 500 may be varied (as mentioned above). This placement can be used to tailor, among other things, the thrust augmentation enabled by the entrained fluid flow. The axial placement of the inlet of the ejector 600 relative to the exit of nozzle 500 can also affect the mass entrainment. For example, placing the ejector 600 upstream of the nozzle 500 exit would produce a positive thrust, since the exiting detonation wave collided on the internal thrust bearing surface 602 of the diverging cross-sectional area. However, positive flow entrainment may be enhanced by a downstream placement of the inlet of ejector 600, as the amount of secondary flow turning through gap 99 is reduced. The cost of such enhanced entrainment is a resulting the impingement of the detonation wave on the ejector inlet walls. This impingement would contribute to a negative thrust production during this portion of the cycle.

Referring with particularity to FIG. 5, a typical cycle associated with the configurations of FIG. 3A, 3B or 4 could be decomposed into five basic temporal phases or regions. In the first, the primary fluid 90 (in the form of a detonation wave) exits from PDE 10, causing an initial flow reversal out of the ejector inlet. In a second phase, positive entrainment of secondary fluid 95 into the ejector inlet ensues. In the third phase, a first period of over-expansion in the detonation chamber 20 causes the primary fluid to flow back into PDE 10. In a fourth phase, steady entrainment is accompanied with strong flow and pressure oscillations, while in the final phase, a second and much stronger period of flow reversal takes place inside the detonation tube. The details of each phase were observed to be affected by the shape of the ejector inlet geometry, the PDE exhaust nozzle and the axial placement of the ejector relative to the exhaust plane of the PDE.

An additional observation can be made regarding the interaction of dynamic shear layer instabilities with the entrainment of the secondary flow 95. During the time between the two flow reversal phases (shown as region IV in FIG. 5), large-scale coherent vortices can form in the exhaust shear layer. These vortices can produce an alternating positive/negative entrainment for the downstream placed ejector, where as the large-scale vortices formed in the initial shear layer, they pushed the secondary flow out of the ejector inlet resulting in negative flow entrainment, after which when the vortices convected downstream, the ejector positively entrained flow again. By moving the ejector upstream, this interaction between the ejector inlet flow and the shear-layer vortices could be decoupled.

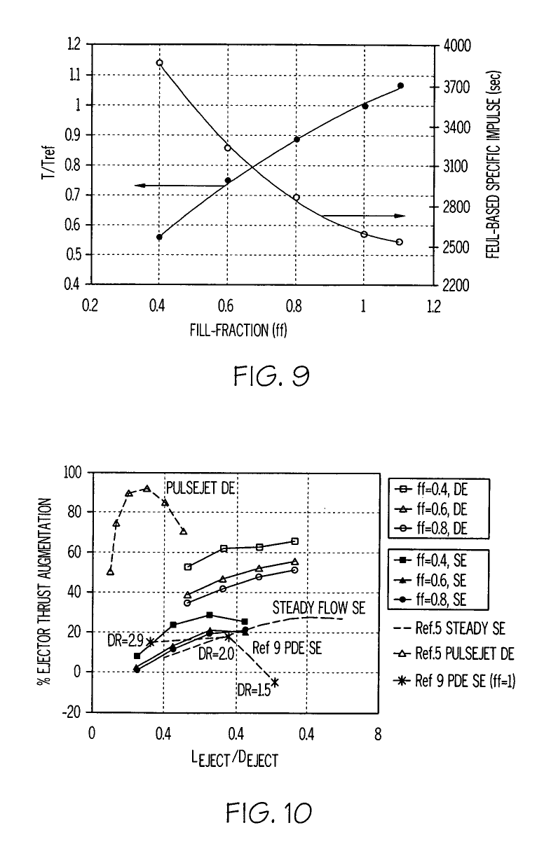

Referring next to FIGS. 6A through 6F, the phases discussed above are shown in simplified form. In FIG. 6A, the detonation wave of primary fluid flow 90 is just exiting the exhaust nozzle 500. In FIG. 6B, while a portion 90A of the primary fluid flow 90 proceeds downstream along a primary flow path, another portion 90B impinges on the surface of the inlet of ejector 600, causing significant drag. The strength of this impingement is directly proportional to the fill fraction in the detonation chamber 20. In FIG. 6C, a portion 90C is forwardly expelled out the ejector inlet. As with the impingement of FIG. 6B, this quantity depends directly on the fill fraction. In FIG. 6D, as the primary fluid flow 90 proceeds downstream, the pressure inside the ejector 600 drops, allowing reintroduction of the portion 90C that was previously expelled from the inlet. During this time, the portion 90C acts like a secondary fluid that is being entrained by the primary fluid flow 90. In FIGS. 6E and 6F, the partial evacuation of detonation chamber 20 coaxes exhaust gases and secondary fluid (both shown as 90C) back into the detonation chamber 20.

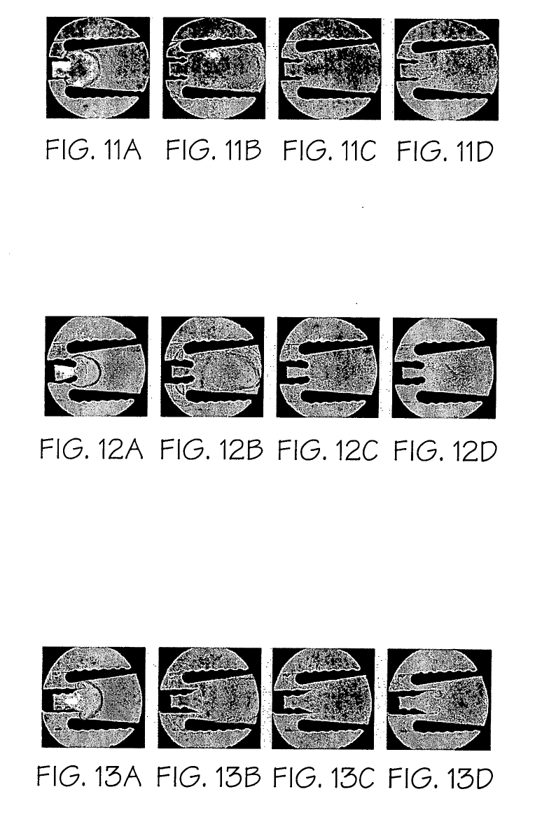

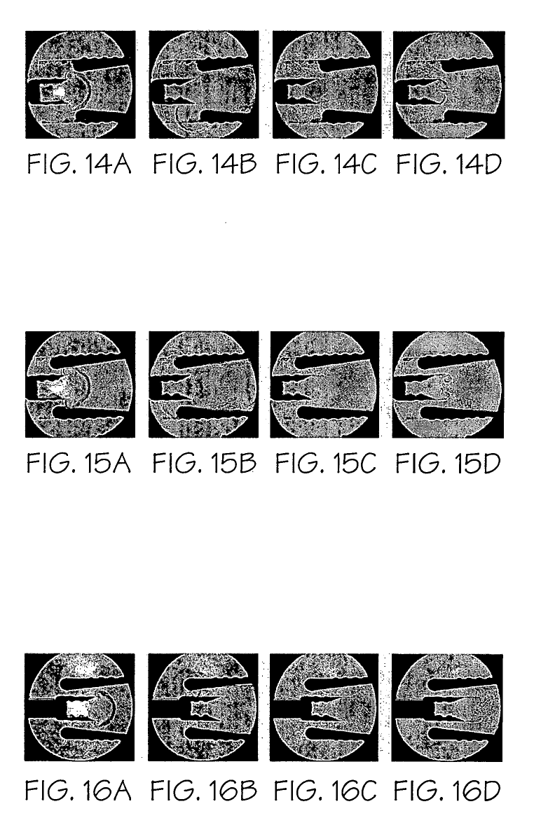

Referring next to FIGS. 7A and 7B, the effect of inlet lip contouring (or shaping) on flow separation is shown. Ejector 700 (shown in FIG. 7A), incorporates a sharp leading-edge lip 705. The turbulence 707 indicates significant flow separation. Contrarily, ejector 800 (shown in FIG. 7B) includes contoured leading-edge lip 805 that produces a considerably more laminar flow of secondary fluid. The reduction in turbulence and related separated flow associated with the contoured lip improves the entrainment of the secondary fluid into the primary fluid and a concomitant increase in thrust from PDE 10.

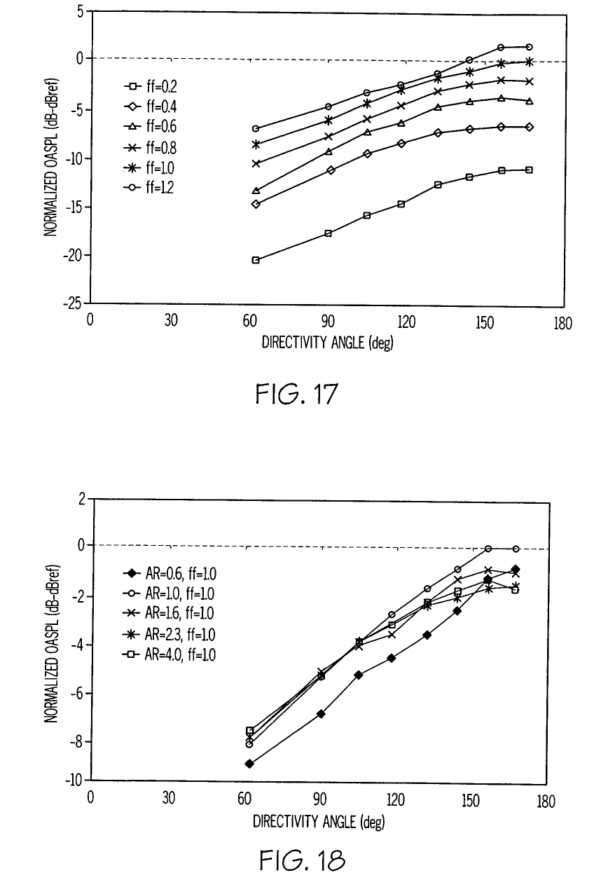

Referring next to FIGS. 8A and 8B, results of thrust augmentation based on variations in fill fraction are shown. Referring with particularity to FIG. 8A, a plot of the percent thrust augmentation for a selected set of the straight and diverging ejectors tested as a function of fill-fraction indicates that the best relative augmentation performance was obtained at the lowest operating fill-fraction, while the level of thrust augmentation was seen to have an inverse relation to fill-fraction. The length to diameter ratios were varied, while the diameter ratio between the ejector and the PDE exhaust was kept at a constant 2.75 and the axial (longitudinal) alignment of the ejector to the exhaust nozzle was separated by two inches. The maximum recorded thrust augmentation was with the longest diverging ejector (L_{EJECT}/D_{EJECT}=5.62) and was on the order of 65% of the baseline thrust at the fill-fraction of 0.4. Doubling the fill-fraction resulted in the relative thrust augmentation to decrease to roughly 51% of the baseline thrust. The dependency on fill-fraction appeared to be similar for straight and diverging ejectors. For the shortest straight ejector (L_{EJECTOR}/D_{EJECTOR}=1.25), negative thrust augmentation (or drag) was measured at the high fill-fraction.

Referring with particularity to FIG. 8B, the relationship between the ejector thrust augmentation and the axial placement of the ejector and the PDE fill-fraction is shown. The thrust augmentation is plotted as a function of fill-fraction for three representative ejector axial placements: upstream, inline and downstream. In both cases, a single ejector length to diameter ratio was studied, using 1.25 for the straight ejector and 5.62 for the diverging ejector. Axial alignment was varied to include an overlap alignment, a separated alignment and an alignment where the exit plane of the exhaust and the inlet plane of the ejector were substantially coplanar. The arrow indicate the direction of downstream changes in axial position of the ejector inlet to the PDE exhaust. Both the straight and diverging ejector configurations showed that as the fill-fraction was increased, the downstream placement performance dropped and the upstream placement performance increased. The inline placement performance stayed nearly constant. Since both the diverging and straight ejector geometries showed very similar trends, the effect of fill-fraction was most likely having a primary affect on the ejector bellmouth and not on the internal thrust surfaces.

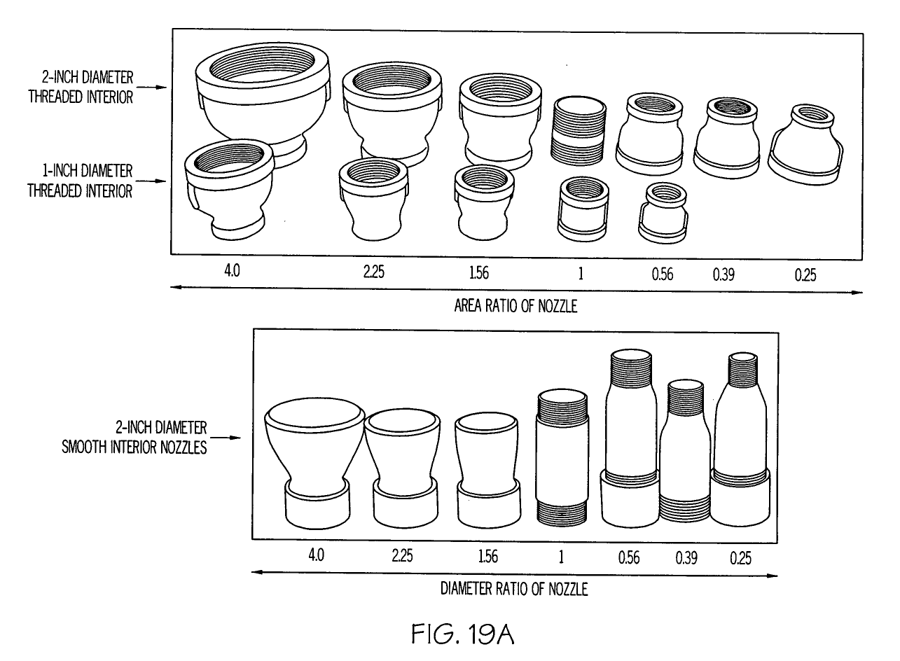

Referring next to FIG. 9, a comparison of the trends between the thrust generated and the specific thrust (i.e., where the effects of fuel consumption are factored in) generated are shown. The maximum thrust occurs at maximum fill-fraction and decreases non-linearly with fill-fraction. This nonlinear drop in thrust with reduced fill-fraction is attributed to the unfilled portion of the detonation tube acting as a straight nozzle. Two sets of expansion waves form during the detonation propagation for a straight nozzle configuration. The first set forms as the detonation shock wave crosses the interface between the filled and unfilled portion of the tube. The second set of expansion waves, which are much stronger than the first, forms as the detonation wave and exhaust gases exit the PDE tube. Essentially, the detonation shock wave serves to compress the gases occupying the unfilled portion of the detonation tube thereby maintaining the pressure inside the detonation tube at a higher pressure. This increased blow-down time with a straight nozzle results in higher thrust. For example, if this straight nozzle or “partial fill” effect were not present, the thrust at a fill-fraction of 0.5 would be approximately 50% of the thrust obtained with a fill-fraction of 1.0. The data in the figure shows that the thrust at a fill-fraction of 0.5 was instead approximately 65%. Thus, a 15% thrust increase was generated by the partial-fill effect at a fill-fraction of 0.5. This effect continued to increase as the fill-fraction was reduced. Also, since the PDE thrust levels decreased at a slower rate than the reduction in fuel mass flow rate, the fuel-based specific impulse values increased as shown in the figure.

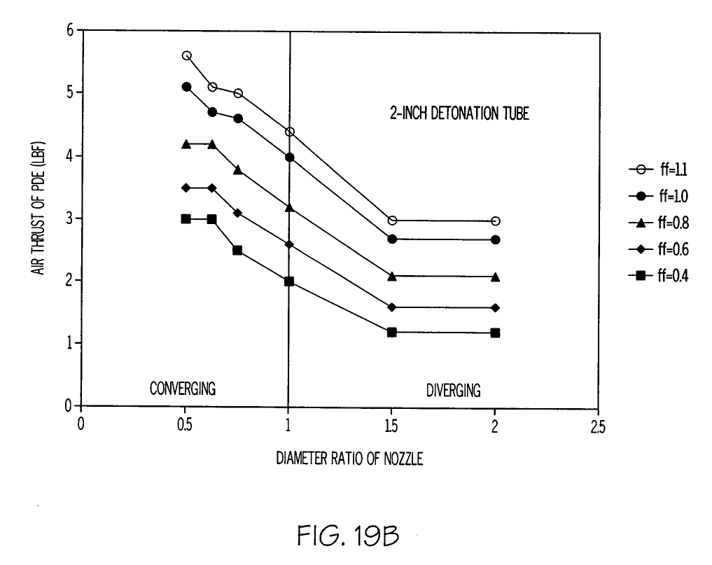

Referring next to FIG. 10, the results of normalizing the straight and diverging ejectors using a constant ejector length to diameter ratio (L_{EJECTOR}/D_{EJECTOR}) of 2.75 is shown. In addition, the ejector inlet is downstream of the exhaust nozzle exit by two inches. A straight ejector operating at a lower fill-fraction is believed to outperform a comparable steady-state ejector. The diverging ejectors indicate nearly twice as much thrust augmentation as the comparable straight ejectors. In addition, the diverging ejectors showed an increase in performance with increased length. The diverging ejectors also show a possible leveling off of performance at L_{EJECTOR}/D_{EJECTOR} around 6.0, a value much greater than the optimum L_{EJECTOR}/D_{EJECTOR} of the straight ejectors.

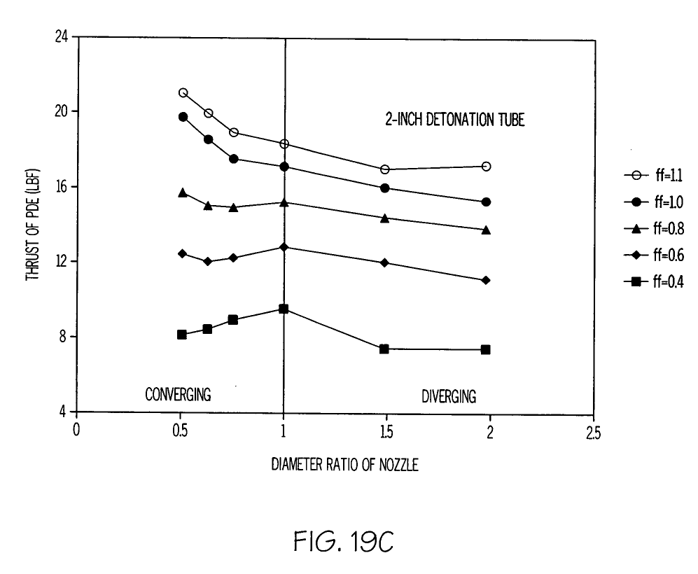

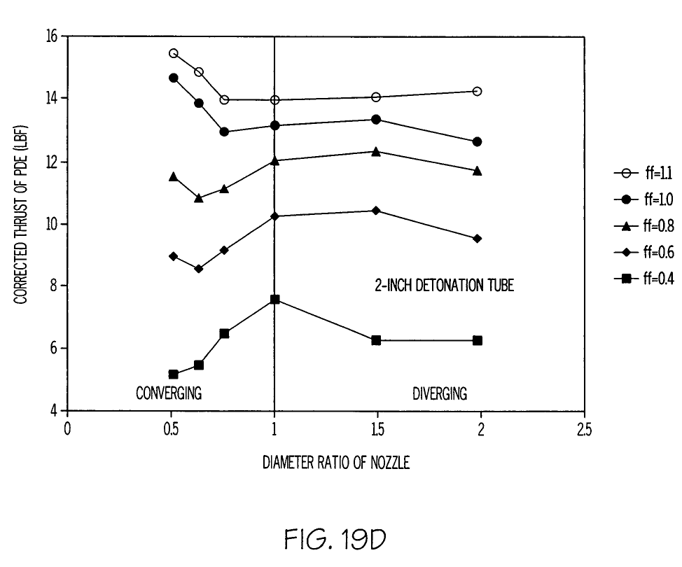

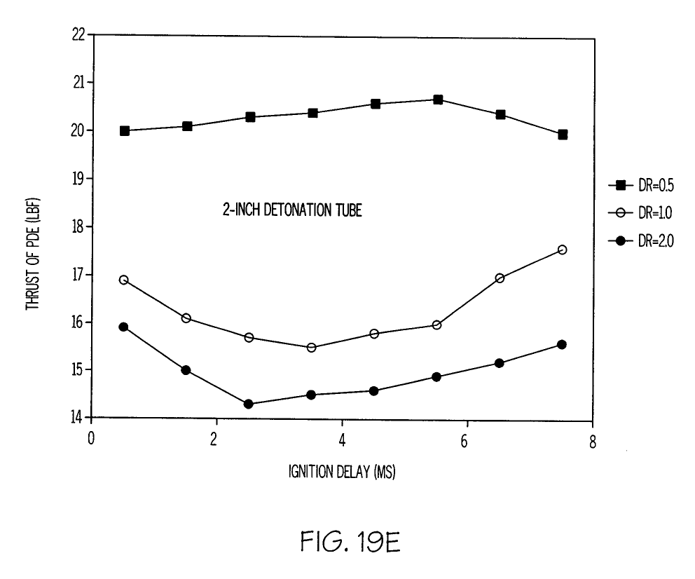

Referring next to FIGS. 11A through 13D, the results of different exhaust nozzle geometries are shown at four different post-detonation times of 0.074 milliseconds (as shown in FIGS. 11A, 12A and 13A), 0.222 milliseconds (as shown in FIGS. 11B, 12B and 13B), 2.148 milliseconds (as shown in FIGS. 11C, 12C and 13C) and 5.444 milliseconds (as shown in FIGS. 11D, 12D and 13D). Referring with particularity to FIGS. 11A through 11D, a straight nozzle is used in conjunction with a diverging ejector. As can be seen, the global structure of the ejector blow-down cycle did not change much with the nozzle configuration, but some details of the process that did vary could contribute to a change in thrust augmentation. First, the structure of the exiting detonation shock wave was altered by the nozzle geometry as seen at time 0.074 ms of FIGS. 11A, 12A and 13A. Although the leading shock wave of the straight and diverging nozzles were both observed to have a flat profile near the axis of the PDE tube, the converging nozzle produced a more axially focused shock wave. This was a result of the shock being accelerated by the area reduction of the converging nozzle. Also, the leading Mach disk was observed at 0.222 ms in FIGS. 11B, 12B and 13B to be located closer to the exit plane of the exhaust nozzle as the area ratio of the nozzle was increased. This signified that the flow at this time was more perfectly expanded with a diverging nozzle than with the straight and converging nozzles. All three nozzles produced similar positive levels of entrainment for the majority of the PDE cycle. The coaxial nature of the ejector and engine flow paths is particularly apparent from the axial overlap seen in FIGS. 13A through 13D.

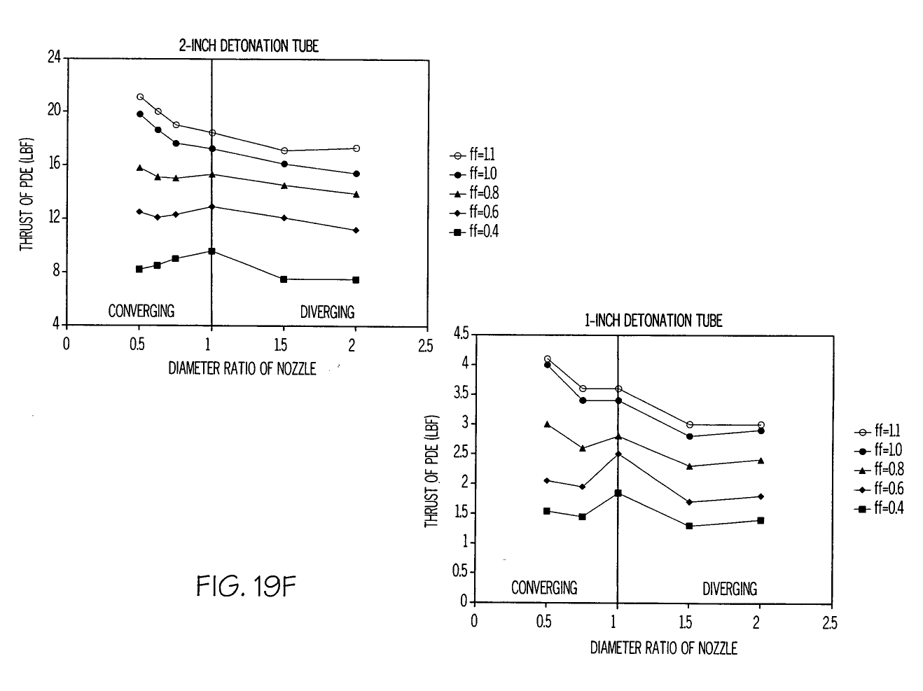

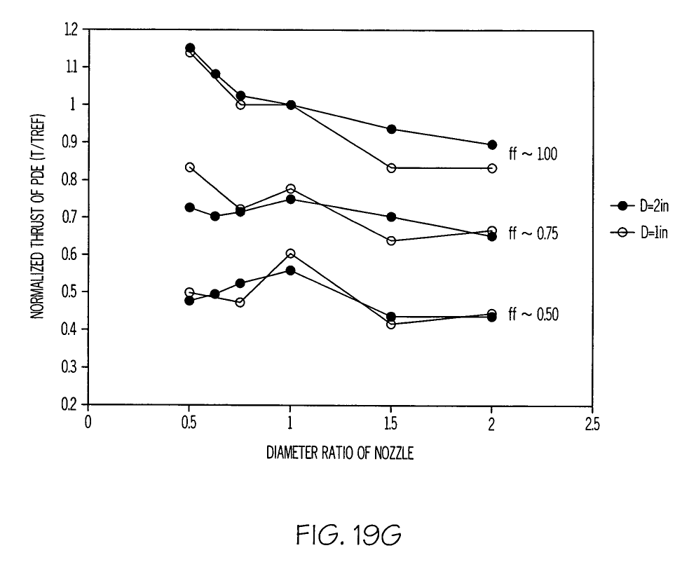

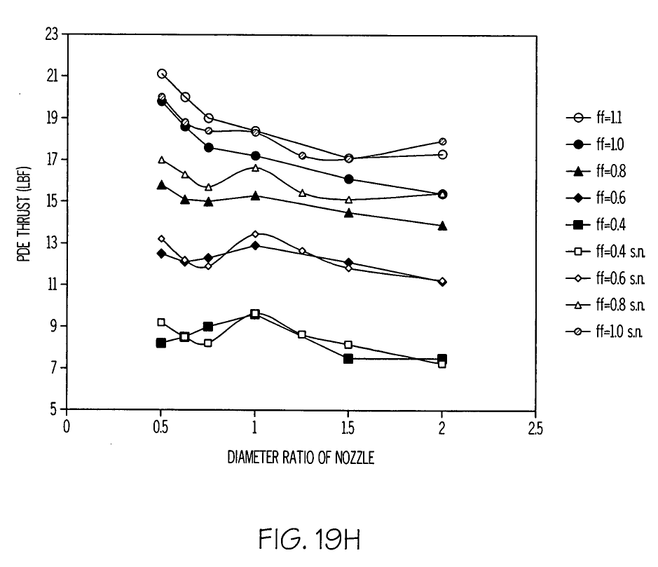

Referring next to FIGS. 14A through 16D, the results of variations in ejector axial placement relative to a diverging exhaust nozzle are shown. Referring with particularity to FIGS. 14A through 14D, the inlet plane of the ejector is situated two inches downstream of the exhaust nozzle exit plane. Referring with particularity to FIGS. 15A through 15D, the inlet plane of the ejector is coplanar with the exhaust nozzle exit plane. Referring with particularity to FIGS. 16A through 16D, the inlet plane of the ejector overlaps the exhaust nozzle exit plane by two inches, such that it is two inches upstream of the exit plane of the exhaust nozzle. As a general trend, the more the ejector is moved downstream relative to the exhaust nozzle, the more air entrainment is possible. Contrarily, this also tends to produce more drag, as can be seen by comparing FIGS. 14A, 15A and 16A, where the most upstream configuration (FIG. 14A) allows the expansion of the exhausted detonation wave to hit the inlet of the ejector, which undesirably increases drag. Accordingly, an optimum position may need to consider the need to balance enhanced air entrainment with drag minimization.

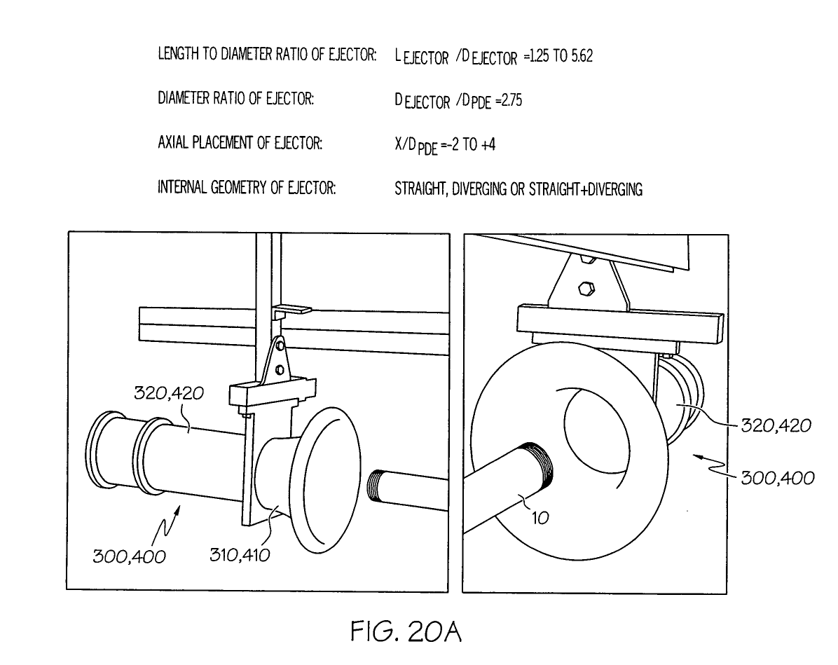

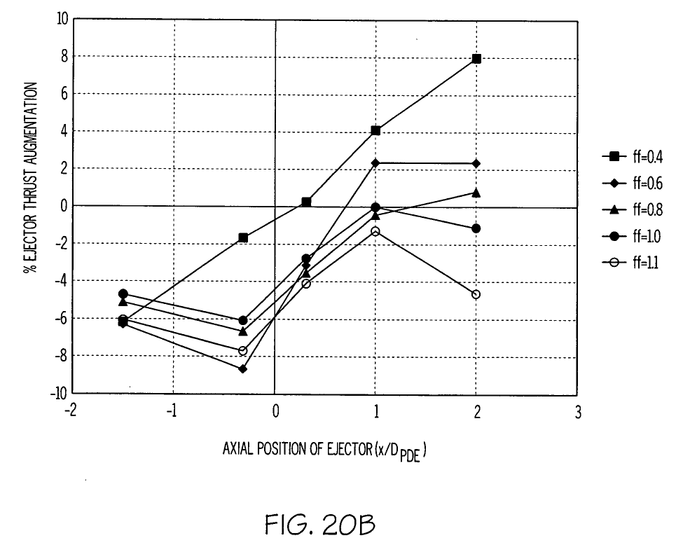

Referring next to FIGS. 17 and 18, the results of variations in fill fraction and nozzle area ratio on acoustic noise is shown. Referring with particularity to FIG. 17, noise directivity for the baseline configuration was plotted against fill-fractions ranging from 0.2 to 1.2. To better visualize the change in acoustic levels with corresponding changes in fill-fraction and directivity angle, the sound pressure levels were adjusted by subtracting a constant baseline reference value of 120 dB. This reference baseline corresponded to the sound pressure level at a fill-fraction of 1.0 and directivity angle of 167°. The figure shows that the strongest noise signature occurred at higher directivity angles (downstream). This is a result of the strength of the exiting detonation wave being strongest along the centerline of the PDE and decaying at a faster rate at the upstream angles due to the expansion waves that form at the exit of the under-expanded PDE tube. In general, as the figures indicate, a significant reduction in acoustic levels can be achieved by a variety of means, either separately or in combination. These include using a converging nozzle, a diverging nozzle, a converging/diverging nozzle and/or varying the operating conditions (e.g., varying the fill-fraction and/or the equivalence ratio). In one particular form, the inventors achieve unidirectional reduction in acoustic levels using a converging nozzle, while achieving downstream acoustic levels using a diverging nozzle.

Referring with particularity to FIG. 18, the effects of the exhaust nozzle geometry were studied by varying the ratio of the nozzle exit area to the detonation tube area. The converging nozzle produced global noise attenuation at all inlet angles and for all tested fill-fractions. Theoretical blast wave models suggest that the rate of decay of a diffracting shock wave scales inversely with its initial diameter. This might suggest that the PDE blast wave, which was shown earlier to be the major source of the PDE noise, has decayed more rapidly due to the smaller exit diameter of the converging nozzle.

The acoustic noise or emissions level is dominated by the strength of the blast wave generate by the detonation inside the engine as the wave exists from the engine. The blast wave strength can be varied by adjusting the fill-fraction of the engine. Referring again to FIG. 17, when the engine is detonating, the reduction in the acoustic level is roughly linear to the fill-fraction. Of course it is desirable to increase efficiency and thrust of the engine while reducing the engine's acoustic emissions. But there are trade-offs in optimizing these parameters. For example, typically a relatively lower fill-fraction yields relatively greater efficiency and relatively lower acoustic emissions, but at the expense of relatively lower thrust.

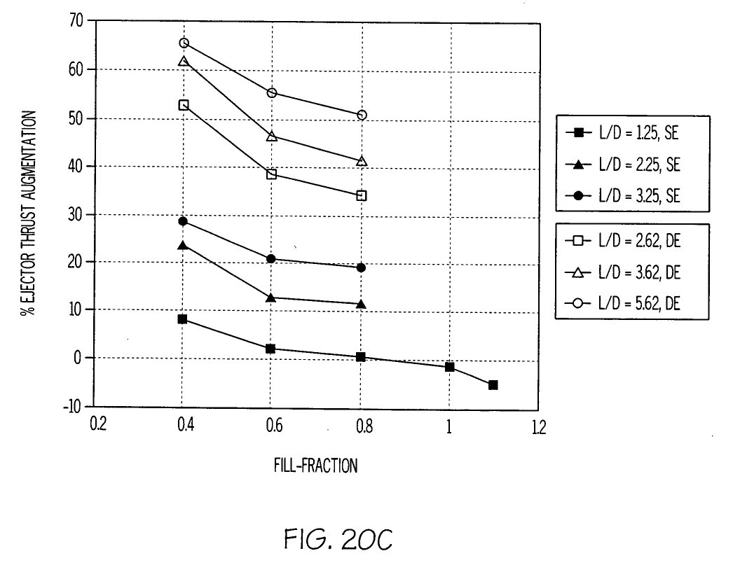

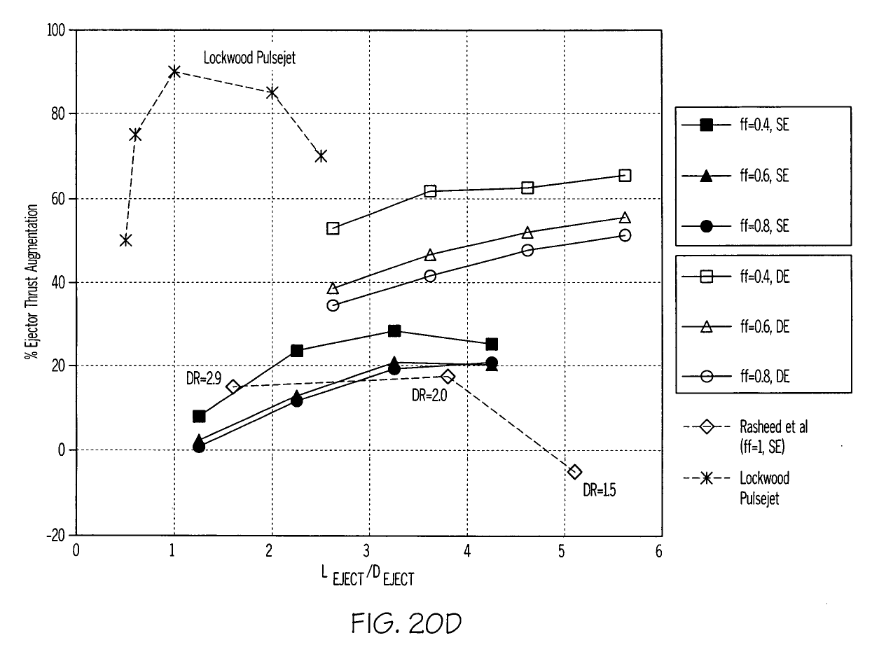

Referring next to FIGS. 19A through 20E, setup and results of experiments conducted on laboratory scale exhaust nozzles and ejectors are shown. The present inventors studied the effects of various factors, including ejector length, fill fraction, divergence of the ejector, the ejector axial position relative to the exhaust aperture and the ejector diameter ratio relative to that of the exhaust aperture. Referring first to FIGS. 19B through 19H, the results of nozzle parametrics are shown, based on both the threaded and smooth internal flowpaths shown in FIG. 19A, including nozzle area ratios between 0.25 and 4.0, where area ratios of less than 1.0 correspond to converging nozzle configurations and area ratios of greater than 1.0 correspond to diverging nozzle configurations. Both one inch and two inch diameter detonation tubes were tested to be compatible with a scaled laboratory detonation tube used to simulate PDE 10. Referring with particularity to FIGS. 19B, 19C and 19D, the results of cold-air thrust (FIG. 19B), gross thrust (FIG. 19C) and detonation thrust (FIG. 19D) are shown, all relative to various fuel fill fractions. As will be appreciated by those skilled in the art, the cold-air thrust is that which is generated by the mere passage of a fluid through the nozzle, while the gross thrust is that which is due to both the passage of the fluid plus the increased pressure due to the detonation. The detonation thrust is that which is due solely to the detonation itself, or the difference between the gross thrust and the cold-air thrust. The results indicate that for low fill fractions (for example, around 0.5 and below), the best thrust performance happens when no nozzle is present, as the thrust improvements offered by the nozzle and its ability to keep engine pressure higher for a longer period are more than offset by the increase in drag of the nozzle. With higher fill fractions, the extra pressure generated by the detonation wave is able to overcome the extra drag. As the fill fraction increased, the thrust was increased in proportion with the degree of nozzle convergence, while there tended to be relatively little dependence on diverging nozzles. Referring with particularity to FIG. 19E, effects of ignition delay were likewise tested on both one and two inch diameter detonation tubes. As a general rule, the diverging nozzles were very sensitive to ignition delay relative to the opening of valves for the detonation. The present inventors believe this is due at least in part to the acoustic behavior of the engine; while converging nozzles are believed to have a damping effect on acoustics, diverging nozzles are thought to allow stronger pressure waves and related oscillations through the exhaust nozzle. Since the effectiveness of a detonation reaction is related to the pressure of the combustible mixture and its surrounding environment, the fluctuating pressure associated with diverging nozzles results in better or worse detonation performance, depending on when the detonation is initiated relative to the local pressure. Referring with particularity to FIG. 19F, a comparison of results for both the one inch and two inch diameter PDE tubes is shown for fill fractions of 0.4, 0.6, 0.8, 1.0 and 1.1. Referring with particularity to FIG. 19G, an overlay of the results for both the one inch and two inch diameter PDE tubes is shown for approximate fill fractions of 0.5, 0.75 and 1.0. This indicates that the results do not depend on the size of the combustion chamber, and that accordingly, at least some degree of scaling is permitted to extend the prediction of PDE thrust performance. Similarly, the results of a smooth versus threaded flowpath are shown in FIG. 19H, to show that early experiments with threads as a minor flow perturbation did not appreciably impact PDE thrust.

Referring with particularity to FIGS. 20A through 20E, an ejector was placed relative to the exhaust end of a laboratory scale detonation tube used to simulate PDE 10. Referring with particularity to FIG. 20A, ejector dimensions and axial placement relative to the tube are shown. Variations in the length to diameter ratio of the ejector were also studied, as were the effects of straight, diverging and straight plus diverging combination internal geometries. As can be seen in FIG. 20D, longer ejector length generally produced greater thrust. Fill fraction played a significant role in thrust augmentation, as FIGS. 20B through 20E indicate. For example, FIG. 20B shows that at lowest fill fraction (0.4), there is a direct correlation between axial position and thrust augmentation, while all higher fill fractions exhibited different dependencies. Generally, the trend is that downstream placement of the ejector relative to the exhaust of the PDE is beneficial in terms of thrust augmentation, subject to the caveat below. As shown in FIG. 20C, thrust augmentation for a diverging ejector was greatest for the lower fill fractions. Similarly, the diverging ejectors produced more thrust than their straight ejector counterparts. One explanation is that there is higher drag in the ejector inlet for higher fill fractions during at least a portion of the operating cycle where the flow reverses. FIG. 20D shows that for a diverging ejector with a relatively long flowpath, thrust augmentation can be significant, between fifty and seventy percent for diverging ejectors and a low fill fraction. FIG. 20E further indicates that there tends to be an optimum value for downstream placement, as at most fill fractions, the placement of the ejector two diameters downstream causes a general peak in thrust augmentation for the experiment setup disclosed herein. The downward trend on the right indicates that the thrust augmentation was less with high fill fractions. As stated above, the inventors believe this was due to the extra drag imparted to the ejector inlet in configurations where it was placed relatively far downstream of the PDE exhaust. Likewise, too much axial overlap between the ejector and the PDE exhaust tends to limit air entrainment, and accordingly reduces thrust augmentation. It can further be seen that where there is no axial overlap, the thrust augmentation was relatively independent of fill fraction, as can be seen by the region inside the circle.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An ejector configured to cooperate with an exhaust nozzle of a pulse detonation engine for improved operability thereof, said ejector comprising:
an inlet section configured to be fluidly coupled to both a primary fluid flow source and a secondary fluid flow source, said primary fluid flow source emanating from said pulse detonation engine; and
an outlet section in fluid communication with said inlet section, said outlet section configured such that the movement of a primary fluid therethrough from said pulse detonation engine promotes entrainment of a secondary fluid through said inlet section and into a primary fluid flowpath defined between said inlet and outlet sections.

2. The ejector of claim 1, wherein said outlet section defines a substantially converging flow path.

3. The ejector of claim 1, wherein said outlet section defines a substantially diverging flow path.

4. The ejector of claim 1, wherein said outlet section defines a substantially axisymmetric fluid flow path.

5. The ejector of claim 1, wherein said inlet section comprises a contoured lip.

6. The ejector of claim 1, wherein a ratio of the length said ejector to the diameter of said ejector at the exit of its outlet section is between three and four.

7. The ejector of claim 1, further comprising an intermediate section disposed between said inlet and outlet sections.

8. A pulse detonation engine comprising:
a detonation chamber configured to generate a time-varying primary fluid;
an exhaust structure defining an opening therein to accept said primary fluid therethrough; and
an ejector fluidly coupled to said exhaust structure such that upon operation of said pulse detonation engine, the movement of said primary fluid through said exhaust structure induces a secondary fluid to pass through said ejector and into a primary fluid flowpath defined by said primary fluid.

9. The pulse detonation engine of claim 8, wherein said exhaust structure of said pulse detonation engine and said ejector are coaxial with one another.

10. The pulse detonation engine of claim 8, wherein said ejector comprises:
an inlet section fluidly coupled to both said exhaust structure and a source of said secondary fluid; and
an outlet section in fluid communication with said inlet section.

11. The pulse detonation engine of claim 10, wherein an exit plane defined in said exhaust structure is substantially axially aligned with an inlet plane defined by said inlet section of said ejector.

12. The pulse detonation engine of claim 10, wherein an exit plane defined in said exhaust structure is substantially axially upstream of an inlet plane defined by said inlet section of said ejector.

13. The pulse detonation engine of claim 10, wherein an exit plane defined in said exhaust structure is substantially axially downstream of an inlet plane defined by said inlet section of said ejector.

14. The pulse detonation engine of claim 8, wherein a cross-sectional area of said ejector is at least twice as large as an axially corresponding cross-sectional area of said exhaust structure.

15. The pulse detonation engine of claim 14, wherein said cross-sectional area of said ejector is between two and one half and three times as large as said axially corresponding cross-sectional area of said exhaust nozzle.

16. The pulse detonation engine of claim 15, wherein said cross-sectional area of said ejector is approximately two and three quarters times as large as said axially corresponding cross-sectional area of said exhaust nozzle.

17. The pulse detonation engine of claim 8, wherein a wherein a ratio of the length said ejector to the diameter of said ejector at the exit of its outlet section is between three and four.

18. The pulse detonation engine of claim 8, wherein said exhaust structure comprises a converging exhaust nozzle.

19. The pulse detonation engine of claim 8, wherein said exhaust structure comprises a diverging exhaust nozzle.

20. The pulse detonation engine of claim 8, wherein said exhaust structure of said pulse detonation engine and said outlet section of said ejector are substantially coaxial.

21. The pulse detonation engine of claim 8, wherein said ejector defines a diverging cross-sectional area from said inlet section to said outlet section.

22. A pulse detonation engine comprising:
a detonation chamber configured to generate a time-varying primary fluid;
an exhaust structure defining an opening therein to accept said primary fluid therethrough; and
an engine performance enhancement device comprising at least one of a nozzle and an ejector, said engine performance enhancement device fluidly coupled to said exhaust structure such that upon passage of said time-varying primary fluid therethrough, at least one performance parameter of said pulse detonation engine is enhanced.

23. A method of operating a pulse detonation engine, said method comprising:
configuring a pulse detonation engine to comprise:
a detonation chamber configured to contain a primary fluid; and
a thrust enhancement device fluidly coupled to said detonation chamber;
generating a detonation wave in said detonation chamber; and
flowing a primary fluid through said thrust enhancement device such that thrust produced by both said thrust enhancement device and said detonation chamber is greater than thrust produced by said detonation chamber alone.

24. The method of claim 23, wherein said thrust enhancement device comprises an exhaust nozzle disposed downstream of said detonation chamber.

25. The method of claim 23, wherein said exhaust nozzle defines a converging flow path.

26. The method of claim 23, wherein said exhaust nozzle defines a diverging flow path.

27. The method of claim 23, wherein said thrust enhancement device comprises an ejector such that the movement of said primary fluid through said ejector promotes entrainment of a secondary fluid therethrough.

28. The method of claim 27, wherein said ejector defines a diverging flow path.

29. The method of claim 27, further comprising forming a contour along an inlet section of said ejector, said contour configured to reduce separation of said secondary fluid.

30. The method of claim 23, further comprising:
defining a fill fraction in said detonation chamber; and
filling said detonation chamber with a mixture of a fuel and an oxidant in accordance with said fill fraction.

31. The method of claim 27, wherein said thrust enhancement device comprises an ejector and an exhaust nozzle configured to be in fluid communication with one another and said pulse detonation engine.

32. The method of claim 23, wherein said generating a detonation wave in said detonation chamber comprises:
introducing fuel and oxidant into said detonation chamber;
introducing fuel and oxidant into a pre-detonation chamber;
igniting said fuel and oxidant in said pre-detonation chamber to produce a deflagration combustion product;
routing said deflagration combustion product through a passage configured to convert said deflagration combustion product into a detonation combustion product;
introducing said detonation combustion product into said detonation chamber;
using said detonation combustion product to compress said fuel and oxidant in said detonation chamber; and
detonating said fuel and oxidant in said detonation chamber such that said primary fluid is produced.

33. The method of claim 32, wherein said generating a detonation wave in said detonation chamber comprises delaying ignition of said fuel and oxidant in said pre-detonation chamber until after a source of at least one of said fuel and oxidant being introduced into said pre-detonation chamber has been fluidly decoupled from said pre-detonation chamber.

34. The method of claim 33, wherein said delaying comprises delaying between one half and seven and one half milliseconds after said fluid decoupling.

35. The method of claim 32, wherein said generating a detonation wave in said detonation chamber comprises timing said igniting to substantially coincide with a localized compression of said fuel and oxidant in said pre-detonation chamber.

36. A method of reducing noise produced by an operating a pulse detonation engine, said method comprising:
configuring a pulse detonation engine to comprise:
a detonation chamber configured to contain a primary fluid;
an exhaust nozzle fluidly coupled to said detonation chamber; and
an ejector fluidly coupled to said exhaust nozzle such that an exhaust fluid flowing therefrom induces air from outside the detonation chamber to mix with said exhaust fluid;
generating a detonation wave in said detonation chamber;
flowing said primary fluid and said outside air through said exhaust nozzle such that the amplitude of sound emanating from said mixture is less than from said primary fluid alone.

37. The method according to claim 36, wherein said exhaust nozzle is a converging nozzle.

38. The method according to claim 37, wherein an area ratio in said converging nozzle is between 0.5 and 0.8.

39. The method according to claim 38, wherein an area ratio in said converging nozzle is approximately 0.6.
